(19) United States
(12) Patent Application Publication
(10) Pub. No.: US 2012/0260766 A1
(43) Pub. Date: Oct. 18, 2012

(54) METHOD, APPARATUS AND SYSTEM FOR REDUCING VIBRATION IN A ROTARY SYSTEM OF A VEHICLE

(75) Inventor: Norbert Seitz, Grobenzell (DE)

(73) Assignee: Prof. Dr. Lars Bertil Carnehammar, Zürich (CH)

(21) Appl. No.: 13/500,280

(22) PCT Filed: Nov. 17, 2010
(86) PCT No.: PCT/EP2010/067686

§ 371 Date: Jun. 21, 2012

(30) Foreign Application Priority Data
Nov. 20, 2009 (EP) 09176603.0
Apr. 28, 2010 (EP) 10161311.5

(51) Int. Cl. F16F 15/173

(52) U.S. Cl. 74/573.1

(57) ABSTRACT

A method of reducing vibration in a rotary system (120, 130) of a motor vehicle, for example a car (100), comprising: balancing said rotary system (120, 130), characterized by providing a rotational element (300, 302-306) comprising a chamber (310-312) having a fulcrum on a rotational axis (340) of said rotational element (300, 302-306), comprising a circumferential balancing area (320) and being partially filled with an amount of a thixotropic balancing substance (330). A corresponding apparatus and system.

### FIELD OF THE INVENTION

Embodiments of the invention described herein relate generally to reducing vibration, and more particularly to a method, an apparatus and a system for reducing vibration in a rotary system of a vehicle, such as an engine or motor system or a power transmission system of a motor vehicle, such as a car.

### BACKGROUND OF THE INVENTION

Vibration is a major environmental factor in vehicles. Vibration negatively effects safety and comfort. With regard to safety, vibration has a direct influence on stability and may cause material fatigue and damage. A main source of vibration is a rotary system of the vehicle, such as an engine system or a power transmission system of a motor vehicle. Vibrations comprise rotation-speed-dependent vibrations generally originating from the engine or motor system and speed-dependent vibrations generally originating from the power transmission system. Vibrations may damage rolling-element bearings, for example ball bearings or roller bearings, used, for example, as engine bearings or wheel bearings, or seals.

Owing to wear and tear of the engine system and power transmission system, vibration in the vehicle generally increases over time. In more detail, owing to wear and tear of a rotating element, it's centre of gravity (CofG) moves over time causing an imbalance causing vibration.

For these and other reasons, there is a need for the invention as set forth in the following in the embodiments.

### SUMMARY OF THE INVENTION

The invention aims to provide a method, an apparatus and a system for reducing vibration in a rotary system of a vehicle, such as an engine or motor system or a power transmission system of a motor vehicle, such as a car.

An aspect of the invention is a method of reducing vibration in a rotary system 120, 130 of a motor vehicle, for example a car 100, comprising balancing said rotary system 120, 130, characterized by providing a rotational element 300, 302-306 comprising a chamber 310-312 having a fulcrum on a rotational axis 340 of said rotational element 300, 302-306, comprising a circumferential balancing area 320 and being partially filled with an amount of a thixotropic balancing substance 330.

The rotary system 120, 130 may be an engine, or a powertrain or powerplant of the motor vehicle. The thixotropic balancing substance 330 is able to flow under the influence of the vibration induced by the rotary system 120, 130. Hence, owing to the vibration, the thixotropic balancing substance 330 distributes itself in the chamber 310 to reduce or minimize the vibration. As a consequence, a centre of gravity (CofG) 350 or centre of rotation (CofR) of the rotary system 120, 130 moves towards an ideal CofR 350, and the method compensates for migration of the CofG. As a further consequence, vibration is reduced, and, as a result, safety is increased, stability is increased and material fatigue is reduced. As a further result, comfort is improved, noise is reduced and, thus, acoustics inside as well as outside the motor vehicle is improved. Furthermore, wear and tear of the motor vehicle, in particular of the rotary system 120, 130, is reduced.

Another aspect of the invention is a method, further comprising rotating said rotational element 300, 302-306 about the rotational axis 340, such that said thixotropic balancing substance 330 liquefies and distributes itself along the circumferential balancing area 320, and an imbalance of said rotational element 300, 302-306 is reduced.

Another aspect of the invention is a method, wherein said rotational axis 340 is oriented horizontally; or said rotational axis 340 is oriented vertically.

Another aspect of the invention is a method, wherein said rotational element 300, 302-306 is an original element of said rotary system 120, 130. As a consequence, the chamber 310 may not require space of its own, and as a result, the chamber 310 may be easy to introduce into motor vehicle design.

Another aspect of the invention is a method, wherein said rotational element 300, 302-306 is a replacement element of said rotary system 120, 130. As a consequence, the chamber 310 may not require space of its own, and as a result, the chamber 310 may be easy to introduce into motor vehicle design. As a further consequence, the rotational element 300, 302-306 may be compatible with the original rotational element, and as a result, the rotational element 300, 302-306 may be used for upgrading the motor vehicle.

Another aspect of the invention is a method, wherein said rotational element 300, 302-306 is a supplemental element to said rotary system 120, 130. As a consequence, the rotational element 300, 302-306 may be compatible with the original rotational element, and as a result, the rotational element 300, 302-306 may be used for upgrading the motor vehicle.

Another aspect of the invention is a method, wherein said rotational element 300, 302-306 is a hollow shaft or tubular shaft; said rotational element 300, 302-306 is an articulated shaft, for example a cardan shaft.

Another aspect of the invention is a method, wherein said rotary system 120, 130 is an engine system 120 of said motor vehicle; said rotational element 300, 302-306 is a crankshaft; or both.

Another aspect of the invention is a method, wherein said rotary system 120, 130 is an power transmission system 130 of said motor vehicle, for example a powertrain or powerplant; said rotational element 300, 302-306 is a shaft 302, for example a driveshaft, such as a main driveshaft 132, front driveshaft 136, front axle driveshaft 137, rear driveshaft 138 or rear axle driveshaft 139, a flywheel or a container; or a combination thereof.

Another aspect of the invention is a method, wherein said chamber 310 is annular or ring-shaped. As a consequence, the chamber 310 may allow, owing to a larger diameter, for an efficient use of the thixotropic balancing substance 330, and as a result, the amount of the thixotropic balancing substance 330 may be reduced. As a further consequence, owing to the cross section being rectangular, semicircle-shaped or bell-shaped, the thixotropic balancing substance 330 may operate most effective, and as a further result, the amount of the thixotropic balancing substance 330 may further be reduced. As a further consequence, owing to the cross section being circular, an air resistance may be reduced, and as a further result, stability may be improved.

Another aspect of the invention is a method, wherein said chamber 310 is cylindrical. As a consequence, the chamber 310 may be compact, and as a result, the chamber 310 may require little space.

Another aspect of the invention is a method, wherein said chamber 310 has a cross section being rectangular, square, semicircle-shaped, bell-shaped or circular.

Another aspect of the invention is a method, wherein said chamber 310 has a diameter of between approximately 0.01 m and approximately 1 m, or between approximately 0.02 m and approximately 0.5 m, or between approximately 0.05 m and approximately 0.2 m, or approximately 0.1 m; said chamber 310 has a length of between approximately 0.01 m and approximately 2 m, or between approximately 0.02 m and approximately 1 m, or between approximately 0.05 m and approximately 0.5 m, or approximately 0.2 m; or a combination thereof. However, the diameter, length or both may be determined by available space.

Another aspect of the invention is a method, wherein said amount of said thixotropic balancing substance 330 is between approximately 0.01 kg and approximately 20 kg, or between approximately 0.1 kg and approximately 2 kg, or between approximately 0.2 kg and approximately 1 kg, or approximately 0.5 kg; said chamber 310 is filled with the amount of said thixotropic balancing substance 330 to between approximately 1% and approximately 90%, or between approximately 10% and approximately 80%, or between approximately 25% and approximately 75%, or approximately 50%; or a combination thereof.

Another aspect of the invention is a method, wherein said chamber 310 comprises a circumferential balancing area 320 with a nanostructure, said nanostructure being, for example, formed by a material, such as a varnish, comprising nanoparticles, or imprinted on said balancing area 320. The nanostructure may be provided by distributing, for example spraying and drying or hardening, the material on the balancing area. Drying or hardening may comprise curing nanomaterial, that is the nanovarnish, using ultra-violet (UV) radiation, that is UV light, for example. The material, that is the nanomaterial, may provide the nanostructure as nanosubstrate. The nanomaterial may comprise two or more components, for instance a first component A, for example a resin, and a second component B, for example a hardener. The nanomaterial may be a two-component material. The nanomaterial, that is the first component A and the second component B, may react by chemical crosslinking or polymerisation. The chemical crosslinking reaction may start immediately or soon after mixing the first component A and the second component B. As a consequence, movability of the thixotropic balancing substance 330 on the balancing area 320 may increase, and as a result, the effect of balancing may be improved.

Another aspect of the invention is a method, wherein said rotational element 300, 302-306 comprises metal, for example steel or aluminium, or composite material, for example glass-fibre-reinforced material or carbon-fibre-reinforced material, or synthetic material, for example plastics or plexiglas. The material is preferably material used elsewhere in the motor vehicle, in particular in the rotary system 120, 130. As a consequence, problems owing to incompatibility may be avoided, and as a result, life time of the motor vehicle, the rotary system 120, 130 or both may be improved, and maintenance may be simplified.

Another aspect of the invention is a method, wherein said thixotropic balancing substance 330 has a yield stress value between approximately 1 Pa and approximately 400 Pa, for example between approximately 2 Pa and approximately 260 Pa, such as approximately 30 Pa. As a consequence, distribution of the thixotropic balancing substance 330 may be improved, and as a result, the effect of the balancing may be improved.

Another aspect of the invention is a method, wherein said thixotropic balancing substance 330 is a balancing gel composition comprising

1) 85 to 97% by weight of a glycol ether component comprising one or more ethylene/propylene glycol copolymer ethers of the general formula (I) or the general (II) or mixtures thereof

R—O{[CH(CH3)CH2—O-]m[CH2—CH2—O-]n}H (I)

R1—(O—{[CH(CH3)CH2—O-]m[CH2—CH2—O-]n}H)2 (II)

wherein
R is hydrogen or an alkyl group of 2-8 carbon atoms;

R1 is an alkylene moiety of 2-8 carbon atoms in which the two substituents are not carried on the same carbon atom;

m is the mole percentage of propylene glycol in the ethylene/propylene glycol copolymer moiety or moieties; and

n is the mole percentage of ethylene glycol in the ethylene/propylene glycol copolymer moiety or moieties, wherein the ratio n:m is in the range from 35:65 to 80:20;

each glycol copolymer compound having a number average molecular weight in the range of 2000-10000; and

2) 3 to 15% by weight of a fumed silica gel former;

said balancing composition being visco-elastic and having a storage modulus (G′) between 1500 Pa and 5000 Pa at 22° C., a loss modulus (G″) smaller than the storage modulus up to a cross-over Frequency of 10-40 Hz, and a Critical Yield Stress exceeding 2 Pa.

Another aspect of the invention is a method, wherein the number average molecular weight of the glycol ether component(s) is/are in the range of 3000-10000.

Another aspect of the invention is a method, wherein the ratio n:m is in the range from 35:65 to 80:20, or in the range from 40:60 to 75:22, or in the range from 40:60 to 60:40, or 50:50.

Another aspect of the invention is a method, wherein the fumed silica gel former is a hydrophilic type fumed silica having a BET surface area of from 90 to 400 m²/g, preferably from 200 to 300 m²/g; or the fumed silica gel former is a hydrophobized type fumed silica having has a BET surface area of from 50 to 300 m²/g, preferably from 250 to 350 m²/g; or mixtures of such hydrophilic and hydrophobized type fumed silica gel formers.

Another aspect of the invention is a method, wherein the glycol ether component(s) exhibit(s) a Viscosity Grade determined according to ISO3448 of above 500, preferably in the range of 800-1200.

Another aspect of the invention is a method, wherein a weight body is in contact with said thixotropic balancing substance 330. As a consequence, the weight body may contribute to balancing of the rotary system 120, 130, and as a result, the effect of the balancing may be improved, and the amount of said thixotropic balancing substance 330 may be reduced.

Another aspect of the invention is a method, wherein said weight body has, defined by a body size of said weight body, a body surface and a body weight, such that said weight body overcomes adhesion between said body surface and said thixotropic balancing substance 330 when said thixotropic balancing substance 330 is subjected to said vibration and changes in an agitated state. As a consequence, the body size ensures movability of the weight body in the chamber 310 with the thixotropic balancing substance 330 therein, and as a result, the effect of the balancing may be improved.

Another aspect of the invention is a method, wherein said weight body preferably is a ball. The body size corresponds with a diameter of the ball. The diameter may be determined by a ratio between the body surface according to A=4 pi r̂2 accounting for surface structure, i. e. roughness, and adhesion, and a body volume according to V=4/3 pi r̂3 accounting for body density and body weight. For increasing radius r, the body volume, and therefore body, weight increases faster than the body surface. As a consequence, movability of the weight body in the chamber 310 may be increased, and as a result, the effect of the balancing may be improved.

Another aspect of the invention is a method, wherein said weight body comprises metal, for example steel, such as stainless steel. As a consequence, durability of the weight body in the chamber 310 may be improved, and as a result, maintenance work may be simplified and reduced.

A further aspect of the invention is an apparatus for reducing vibration in a rotary system 120, 130 of a motor vehicle, for example a car 100, characterized by a rotational element 300, 302-306 comprising a chamber 310-312 having a fulcrum on a rotational axis 340 of said rotational element 300, 302-306, comprising a circumferential balancing area 320 and being partially filled with an amount of a thixotropic balancing substance 330.

Yet a further aspect of the invention is a rotary system 120, 130 of a motor vehicle, for example a car 100, for reducing vibration in said rotary system 120, 130, characterized by a rotational element 300, 302-306 comprising a chamber 310-312 having a fulcrum on a rotational axis 340 of said rotational element 300, 302-306, comprising a circumferential balancing area 320 and being partially filled with an amount of a thixotropic balancing substance 330.

Yet a further aspect of the invention is the use of a method of reducing vibration in a rotary system 120, 130 of a motor vehicle, for example a car 100, said method comprising balancing said rotary system 120, 130; and providing a rotational element 300, 302-306 comprising a chamber 310-312 having a fulcrum on a rotational axis 340 of said rotational element 300, 302-306, comprising a circumferential balancing area 320 and being partially filled with an amount of a thixotropic balancing substance 330.

Another aspect of the invention is a method of reducing vibration in a rotary system 120, 130, 440 of rolling stock, for example a locomotive, passenger car 404 or freight car 406, comprising balancing said rotary system 120, 130, 440, characterized by providing a rotational element 300, 302-306; 442, 446, 448, comprising a chamber 310-312; 444 having a fulcrum on a rotational axis 340 of said rotational element 300, 302-306; 442, 446, 448 comprising a circumferential balancing area 320 and being partially filled with an amount of a thixotropic balancing substance 330.

Another aspect of the invention is a method of reducing vibration in a rotary system 120, 130, 440 of rolling stock, for example a locomotive, passenger car 404 or freight car 406, comprising balancing said rotary system 120, 130, 440, characterized by providing a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

The rotary system 120, 130, 440 may be an engine, a powertrain or powerplant, or wheelset of rolling stock. The thixotropic balancing substance 330 is able to flow under the influence of the vibration induced by the rotary system 120, 130, 440. Hence, owing to the vibration, the thixotropic balancing substance 330 distributes itself in the chamber 310-312; 444 to reduce or minimize the vibration. As a consequence, the CofG 350 or CofR of the rotary system 120, 130, 440 moves towards the ideal CofR 350, and the method compensates for migration of the CofG. As a further consequence, vibration is reduced, and, as a result, safety is increased, stability is increased and material fatigue is reduced. As a further result, comfort is improved, noise is reduced and, thus, acoustics inside as well as outside the rolling stock is improved. Furthermore, wear and tear of the rolling stock, in particular of the rotary system 120, 130, 440, is reduced.

Another aspect of the invention is a method, further comprising rotating said rotational element 300, 302-306; 442, 446, 448 about the rotational axis 340, such that said thixotropic balancing substance 330 liquefies and distributes itself along the circumferential balancing area 320, and an imbalance of said rotational element 300, 302-306; 442, 446, 448 is reduced.

Another aspect of the invention is a method, wherein said rotational axis 340 is oriented horizontally; or said rotational axis 340 is oriented vertically.

Another aspect of the invention is a method, wherein said rotational element 300, 302-306; 442, 446, 448 is an original element of said rotary system 120, 130, 440. As a consequence, the chamber 310-312; 444 may not require space of its own, and as a result, the chamber 310-312; 444 may be easy to introduce into rolling stock design.

Another aspect of the invention is a method, wherein said rotational element 300, 302-306; 442, 446, 448 is a replacement element of said rotary system 120, 130, 440. As a consequence, the chamber 310-312, 444 may not require space of its own, and as a result, the chamber 310-312; 444 may be easy to introduce into rolling stock design. As a further consequence, the rotational element 300, 302-306; 442, 446, 448 may be compatible with the original rotational element, and as a result, the rotational element 300, 302-306; 442, 446, 448 may be used for upgrading the rolling stock.

Another aspect of the invention is a method, wherein said rotational element 300, 302-306; 442, 446, 448 is a supplemental element to said rotary system 120, 130; 440. As a consequence, the rotational element 300, 302-306; 442, 446, 448 may be compatible with the original rotational element, and as a result, the rotational element 300, 302-306; 442, 446, 448 may be used for upgrading the rolling stock.

Another aspect of the invention is a method, wherein said rotational element 300, 302-306; 442, 446, 448 is a hollow shaft or tubular shaft; said rotational element 300, 302-306; 442, 446, 448 is an articulated shaft, for example a cardan shaft.

Another aspect of the invention is a method, wherein said rotary system 120, 130, 440 is an engine system 120 of said rolling stock; said rotational element 300, 302-306 is a crankshaft; or both.

Another aspect of the invention is a method, wherein said rotary system 120, 130, 440 is an power transmission system 130 of said rolling stock, for example a powertrain or powerplant; said rotational element 300, 302-306; 442, 446, 448 is a shaft 302, for example a driveshaft, a flywheel or a container; or a combination thereof.

Another aspect of the invention is a method, wherein said chamber 310-312; 444 is annular or ring-shaped. As a consequence, the chamber 310-312; 444 may allow, owing to a larger diameter, for an efficient use of the thixotropic balancing substance 330, and as a result, the amount of the thixotropic balancing substance 330 may be reduced. As a further consequence, owing to the cross section being rectangular, semicircle-shaped or bell-shaped, the thixotropic balancing substance 330 may operate most effective, and as a further result, the amount of the thixotropic balancing substance 330 may further be reduced. As a further consequence, owing to the cross section being circular, an air resistance may be reduced, and as a further result, stability may be improved.

Another aspect of the invention is a method, wherein said chamber 310-312; 444 is cylindrical. As a consequence, the chamber 310-312; 444 may be compact, and as a result, the chamber 310-312; 444 may require little space.

Another aspect of the invention is a method, wherein said chamber 310-312; 444 has a cross section being rectangular, square, semicircle-shaped, bell-shaped or circular.

Another aspect of the invention is a method, wherein said chamber 310-312; 444 has a diameter of between approximately 0.01 m and approximately 1 m, or between approximately 0.02 m and approximately 0.5 m, or between approximately 0.05 m and approximately 0.2 m, or approximately 0.1 m; said chamber 310-312; 444 has a length of between approximately 0.01 m and approximately 2 m, or between approximately 0.02 m and approximately 1 m, or between approximately 0.05 m and approximately 0.5 m, or approximately 0.2 m; or a combination thereof. However, the diameter, length or both may be determined by available space.

Another aspect of the invention is a method, wherein said amount of said thixotropic balancing substance 330 is between approximately 0.01 kg and approximately 20 kg, or between approximately 0.1 kg and approximately 2 kg, or between approximately 0.2 kg and approximately 1 kg, or approximately 0.5 kg; said chamber 310 is filled with the amount of said thixotropic balancing substance 330 to between approximately 1% and approximately 90%, or between approximately 10% and approximately 80%, or between approximately 25% and approximately 75%, or approximately 50%; or a combination thereof.

Another aspect of the invention is a method, wherein said chamber 310-312; 444 comprises a circumferential balancing area 320 with a nanostructure, said nanostructure being, for example, formed by a material, such as a varnish, comprising nanoparticles, or imprinted on said balancing area 320. The nanostructure may be provided by distributing, for example spraying and drying or hardening, the material on the balancing area. Drying or hardening may comprise curing nanomaterial, that is the nanovarnish, using ultra-violet (UV) radiation, that is UV light, for example. The material, that is the nanomaterial, may provide the nanostructure as nanosubstrate. The nanomaterial may comprise two or more components, for instance a first component A, for example a resin, and a second component B, for example a hardener. The nanomaterial may be a two-component material. The nanomaterial, that is the first component A and the second component B, may react by chemical crosslinking or polymerisation. The chemical crosslinking reaction may start immediately or soon after mixing the first component A and the second component B. As a consequence, movability of the thixotropic balancing substance 330 on the balancing area 320 may increase, and as a result, the effect of balancing may be improved.

Another aspect of the invention is a method, wherein said rotational element 300, 302-306; 442, 446, 448 comprises metal, for example steel or aluminium, or composite material, for example glass-fibre-reinforced material or carbon-fibre-reinforced material, or synthetic material, for example plastics or plexiglas. The material is preferably material used elsewhere in the rolling stock, in particular in the rotary system 120, 130, 440. As a consequence, problems owing to incompatibility may be avoided, and as a result, life time of the rolling stock, the rotary system 120, 130, 440 or both may be improved, and maintenance may be simplified.

Another aspect of the invention is a method, wherein said thixotropic balancing substance 330 has a yield stress value between approximately 1 Pa and approximately 400 Pa, for example between approximately 2 Pa and approximately 260 Pa, such as approximately 30 Pa. As a consequence, distribution of the thixotropic balancing substance 330 may be improved, and as a result, the effect of the balancing may be improved.

Another aspect of the invention is a method, wherein said thixotropic balancing substance 330 is a balancing gel composition comprising

1) 85 to 97% by weight of a glycol ether component comprising one or more ethylene/propylene glycol copolymer ethers of the general formula (I) or the general (II) or mixtures thereof

R—O{[CH(CH3(CH2—O-]m[CH2—CH2—O-]n}H (I)

R1—(O—{[CH(CH3)CH2—O-]m[CH2—CH2—O-]n}H)2 (II)

wherein

R is hydrogen or an alkyl group of 2-8 carbon atoms;

R1 is an alkylene moiety of 2-8 carbon atoms in which the two substituents are not carried on the same carbon atom;

m is the mole percentage of propylene glycol in the ethylene/propylene glycol copolymer moiety or moieties; and

n is the mole percentage of ethylene glycol in the ethylene/propylene glycol copolymer moiety or moieties, wherein the ratio n:m is in the range from 35:65 to 80:20;

each glycol copolymer compound having a number average molecular weight in the range of 2000-10000; and

2) 3 to 15% by weight of a fumed silica gel former;

said balancing composition being visco-elastic and having a storage modulus (G′) between 1500 Pa and 5000 Pa at 22° C., a loss modulus (G″) smaller than the storage modulus up to a cross-over Frequency of 10-40 Hz, and a Critical Yield Stress exceeding 2 Pa.

Another aspect of the invention is a method, wherein the number average molecular weight of the glycol ether component(s) is/are in the range of 3000-10000.

Another aspect of the invention is a method, wherein the ratio n:m is in the range from 35:65 to 80:20, or in the range from 40:60 to 75:22, or in the range from 40:60 to 60:40, or 50:50.

Another aspect of the invention is a method, wherein the fumed silica gel former is a hydrophilic type fumed silica having a BET surface area of from 90 to 400 m²/g, preferably from 200 to 300 m²/g; or the fumed silica gel former is a hydrophobized type fumed silica having has a BET surface area of from 50 to 300 m²/g, preferably from 250 to 350 m²/g; or mixtures of such hydrophilic and hydrophobized type fumed silica gel formers.

Another aspect of the invention is a method, wherein the glycol ether component(s) exhibit(s) a Viscosity Grade determined according to ISO3448 of above 500, preferably in the range of 800-1200.

Another aspect of the invention is a method, wherein a weight body is in contact with said thixotropic balancing substance 330. As a consequence, the weight body may contribute to balancing of the rotary system 120, 130, 440, and as a result, the effect of the balancing may be improved, and the amount of said thixotropic balancing substance 330 may be reduced.

Another aspect of the invention is a method, wherein said weight body has, defined by a body size of said weight body, a body surface and a body weight, such that said weight body overcomes adhesion between said body surface and said thixotropic balancing substance 330 when said thixotropic balancing substance 330 is subjected to said vibration and changes in an agitated state. As a consequence, the body size ensures movability of the weight body in the chamber 310-312; 444 with the thixotropic balancing substance 330 therein, and as a result, the effect of the balancing may be improved.

Another aspect of the invention is a method, wherein said weight body preferably is a ball. The body size corresponds with a diameter of the ball. The diameter may be determined by a ratio between the body surface according to A=4 pi r̂2 accounting for surface structure, i. e. roughness, and adhesion, and a body volume according to V=4/3 pi r̂3 accounting for body density and body weight. For increasing radius r, the body volume, and therefore body, weight increases faster than the body surface. As a consequence, movability of the weight body in the chamber 310 may be increased, and as a result, the effect of the balancing may be improved.

Another aspect of the invention is a method, wherein said weight body comprises metal, for example steel, such as stainless steel. As a consequence, durability of the weight body in the chamber 310 may be improved, and as a result, maintenance work may be simplified and reduced.

A further aspect of the invention is an apparatus for reducing vibration in a rotary system 120, 130, 440 of rolling stock, for example a locomotive, passenger car 404 or freight car 406, characterized by a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

Yet a further aspect of the invention is a rotary system 120, 130, 400 of rolling stock, for example a locomotive, passenger car 404 or freight car 406, for reducing vibration in said rotary system 120, 130, 440, characterized by a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

Yet a further aspect of the invention is the use of a method of reducing vibration in a rotary system 120, 130, 440 of rolling stock, for example a locomotive, passenger car 404 or freight car 406, said method comprising balancing said rotary system 120, 130, 440; and providing a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

Another aspect of the invention is a method of reducing vibration in a rotary system 120, 130, 440 of a vehicle, comprising balancing said rotary system 120, 130, 440, characterized by providing a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

A further aspect of the invention is an apparatus for reducing vibration in a rotary system 120, 130, 440 of a vehicle, characterized by a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

Yet a further aspect of the invention is a rotary system 120, 130, 440 of a vehicle for reducing vibration in said rotary system 120, 130, characterized by a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

Yet a further aspect of the invention is the use of a method of reducing vibration in a rotary system 120, 130, 440 of a vehicle, said method comprising balancing said rotary system 120, 130, 440; and providing a rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of a thixotropic balancing substance 330.

### BRIEF DESCRIPTION OF THE SEVERAL VIEWS OF THE DRAWING(S)

While the specification concludes with claims particularly pointing out and distinctly claiming that which is regarded as the invention, a more particular description of the invention will be rendered by reference to specific embodiments thereof, which are depicted in the appended drawings, in order to illustrate the manner in which embodiments of the invention are obtained. Understanding that these drawings depict only typical embodiments of the invention, that are not necessarily drawn to scale, and, therefore, are not to be considered limiting of its scope, embodiments will be described and explained with additional specificity and detail through use of the accompanying drawings in which:

FIG. 1 shows a schematic view of a wheeled motor vehicle, such as a car, to which the invention may be applied;

FIG. 2 shows a cross-sectional view of a chamber in a shaft, such as a driveshaft, according to an embodiment of the invention;

FIG. 3 shows a cross-sectional view of a chamber in a shaft, such as a driveshaft, according to another embodiment of the invention;

FIG. 4 shows a cross-sectional view of a chamber in a shaft, such as a driveshaft, according to yet another embodiment of the invention;

FIG. 5 shows a cross-sectional view of a plurality of chambers in a shaft, a driveshaft, according to yet another embodiment of the invention;

FIG. 6 shows, for a preferred embodiment of the invention, a cross-sectional view of the cylindrical chamber at an initial point in time;

FIG. 7 shows, for the preferred embodiment of the invention, a cross-sectional view of the cylindrical chamber at a point in time, when the thixotropic balancing substance is distributed along the circumferential balancing area of the chamber;

FIG. 8 shows a cross-sectional view of a chamber in a rotational element according to yet another embodiment of the invention;

FIG. 9 shows a cross-sectional view of a chamber in a rotational element according to yet another embodiment of the invention; and

FIG. 10 shows a cross-sectional view of a chamber in another rotational element according to yet another embodiment of the invention;

FIGS. 11 to 13 show a schematic view of rolling stock, such as a locomotive, passenger car and freight car, to which the invention may be applied; and

FIG. 14 shows a cross-sectional view of a wheelset of the rolling stock, to which the invention may be applied.

### DETAILED DESCRIPTION OF THE INVENTION

In the following detailed description of the embodiments, reference is made to the accompanying drawings which form a part hereof and show, by way of illustration, specific embodiments in which the invention may be practiced. In the drawings, like numerals describe substantially similar components throughout the several views. The embodiments are intended to describe aspects of the invention in sufficient detail to enable those of skill in the art to practice the invention. Other embodiments may be utilized and structural, logical or electrical changes or combinations thereof may be made without departing from the scope of the invention. Moreover, it is to be understood, that the various embodiments of the invention, although different, are not necessarily mutually exclusive. For example, a particular feature, structure or characteristic described in one embodiment may be included within other embodiments. Furthermore, it is to be understood, that embodiments of the invention may be implemented using different technologies. Also, the term “exemplary” is merely meant as an example, rather than the best or optimal. The following detailed description is, therefore, not to be taken in a limiting sense, and the scope of the invention is defined only by the appended claims, along with the full scope of equivalents to which such claims are entitled.

Reference will be made to the drawings. In order to show the structures of the embodiments most clearly, the drawings included herein are diagrammatic representations of inventive articles. Thus, actual appearance of the fabricated structures may appear different while still incorporating essential structures of embodiments. Moreover, the drawings show only the structures necessary to understand the embodiments. Additional structures known in the art have not been included to maintain clarity of the drawings. It is also to be understood, that features and/or elements depicted herein are illustrated with particular dimensions relative to one another for purposes of simplicity and ease of understanding, and that actual dimensions may differ substantially from that illustrated herein.

In the following description and claims, the terms “include”, “have”, “with” or other variants thereof may be used. It is to be understood, that such terms are intended to be inclusive in a manner similar to the term “comprise”.

In the following description and claims, the terms “coupled” and “connected”, along with derivatives such as “communicatively coupled” may be used. It is to be understood, that these terms are not intended as synonyms for each other. Rather, in particular embodiments, “connected” may be used to indicate, that two or more elements are in direct physical or electrical contact with each other. However, “coupled” may also mean that two or more elements are not in direct contact with each other, but yet still co-operate or interact with each other.

In the following description and claims, terms, such as “upper”, “lower”, “first”, “second”, etc., may be only used for descriptive purposes and are not to be construed as limiting. The embodiments of a device or article described herein can be manufactured, used, or shipped in a number of positions and orientations.

Vehicles comprise wheeled motor vehicles, such as automobiles, lorries and motorcycles. An automobile or passenger car (“car”) is a wheeled motor vehicle for transporting passengers. A lorry or truck is a commercial motor vehicle for transporting goods or materials. A motorcycle or motorbike is a single-track motor vehicle.

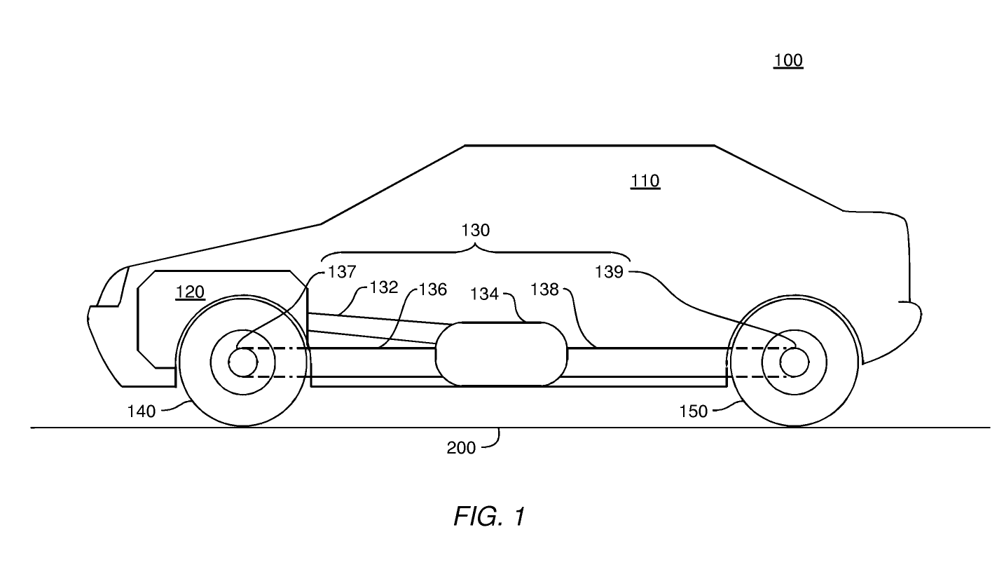

FIG. 1 shows a schematic view of a wheeled motor vehicle, such as a car 100, to which the invention may be applied. The car 100 comprises a body 110, an engine or motor 120, a powertrain or powerplant 130, front wheels 140 and rear wheels 150.

The engine 120 is situated in the body 110. In more detail, the engine 120 may be located in a front section of the car 100 as shown in FIG. 1, in a centre section or a rear section. The engine 120 generates power, such as rotational power, or energy, such as rotational energy, for propelling the car 100 and may be a combustion engine, such as a petrol engine or gasoline engine or a Diesel engine, or an electrical engine, or a combination thereof (hybrid engine). Accordingly, the engine 120 may consume wood, fossil fuel, for example coal, petrol or fuel oil, such as heavy fuel oil, or gas, such as liquefied natural gas (LNG), solar energy or electrical energy, such as stored electrical energy.

The powertrain 130 is coupled to the engine 120 and at least some of the front wheels 140 and back wheels 150 for distributing the power or energy from the engine 120 to the front wheels 140, rear wheels 150 or both. The powertrain 130 may comprise a main driveshaft 132, a centre differential 134, a front driveshaft 136, front axle driveshafts 137, a rear driveshaft 138 and rear axle driveshafts 139. The main driveshaft 132 couples the engine 120 to the centre differential 134 and communicates the power from the engine 120 to the centre differential 134. The centre differential 134 distributes the power as a front power to the front driveshaft 136 and as a rear power to the rear driveshaft 139. The front driveshaft 136 couples the centre differential 134 to the front axle driveshafts 137 and communicates the front power to the front axle driveshafts 137. The front axle driveshafts 137 are coupled to the front wheels 140, respectively, and communicate the front power to the front wheels 140. The rear driveshaft 138 couples the centre differential 134 to the rear axle driveshafts 139 and communicates the rear power to the rear axle driveshafts 137. The rear axle driveshafts 139 are coupled to the rear wheels 150, respectively, and communicate the rear power to the rear wheels 150. One, two, three, or more of the driveshafts may be hollow shafts or tubular shafts. One, two, three, or more of the driveshafts may be articulated shafts, for example cardan shafts, each comprising a cardan joint. The front wheels 140 and rear wheels 150 apply the power to a surface of a road 200 or terrain for propelling the car 100. Thus, the car 100 shown in FIG. 1 is a four-wheel-drive vehicle. Alternatively, a vehicle may be a two wheel-drive vehicle, for example a front-wheel-drive vehicle or a rear-wheel-drive vehicle.

The powertrain 130 may further comprise a flywheel (not shown), such a dual-mass flywheel, for storing rotational power. The powertrain 130 may further comprise a gearbox (not shown), such as a manual gearbox or an automatic gearbox, for converting speed and torque of the power.

Alternatively, the invention may be applied to non-wheel-based motor vehicle, such as continuous-track motor vehicles or tracked vehicles, for examples caterpillars.

The engine 120 may comprise a rotational element, such as a crank shaft or an additional element, for example a container or vessel.

The powertrain 130 may comprise a rotational element, such as the main driveshaft 132, front driveshaft 136, front axle driveshafts 137, rear driveshaft 138, rear axle driveshafts 139, flywheel, or a gearing wheel or an additional element, for example a container or vessel.

According to embodiments of the invention, one, two, three or more rotational elements 300 of the engine 120, powertrain 130 or both comprise one, two, three or more chambers 310-312 having a fulcrum on a rotational axis (340), comprising a circumferential balancing area 320 and being partially filled with an amount of a thixotropic balancing substance 330. The one, two, three or more rotational elements 300 comprising one, two, three or more chambers 310-312 may comprise metal, for example steel or aluminium, or composite material, for example glass-fibre-reinforced material or carbon-fibre-reinforced material, or synthetic material, for example plastics or plexiglas. The one, two, three or more rotational elements 300 comprising one, two, three or more chambers 310-312 may replace original rotational elements of the rotational system 120, 130. The one, two, three or more rotational elements 300 comprising one, two, three or more chambers 310-312 may supplement the rotational system 120, 130.

The chamber 310-312 may be caved into the rotational element 300. Alternatively, the chamber 310-312 may be situated in a hollow shaft or tubular shaft, and extend partially or fully, such as substantially fully, along the hollow shaft or tubular shaft.

The circumferential balancing area 320 may comprise a nanostructure for improving movability and flow of the thixotropic balancing substance 330, said nanostructure being, for example, formed by a material, such as a varnish, comprising nanoparticles, or imprinted on said circumferential balancing area 320.

Further, the invention may be applied to a real motor vehicle, such as a car in real life, as well as a scale motor vehicle, such as a model car.

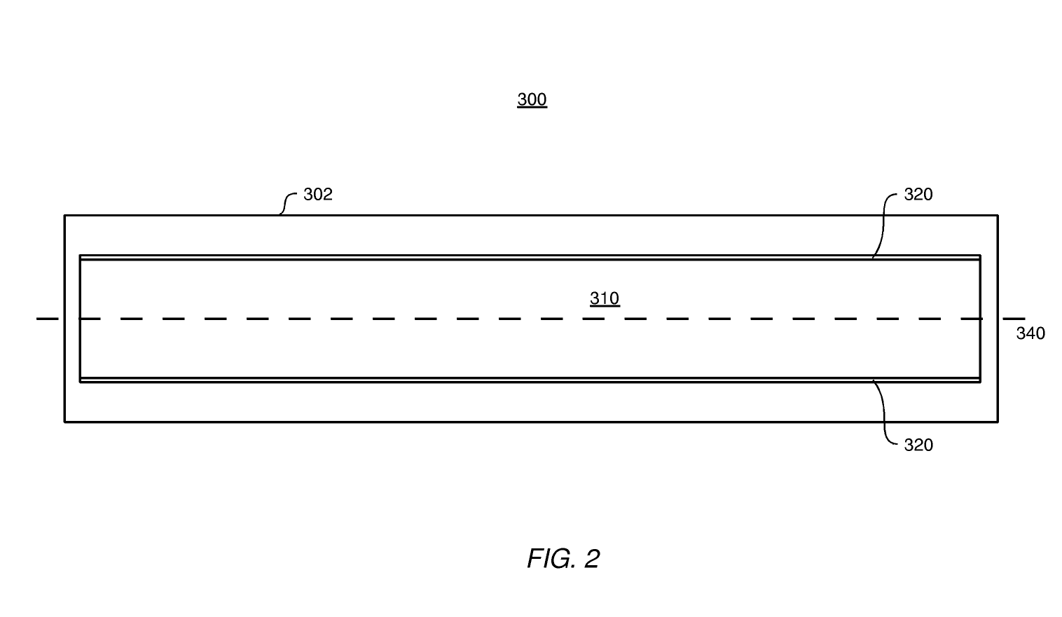

FIG. 2 shows a cross-sectional view of a chamber 310 in a shaft 302, such as a driveshaft 132, 136-139, according to an embodiment of the invention. The chamber 310 is situated in a hollow shaft or tubular shaft, and extends substantially fully along the hollow shaft or tubular shaft. Ends of the hollow shaft or tubular shaft may be sealed or closed with lids. The shaft 302 is rotatable about a rotational axis 340. The chamber 310 comprises a circumferential balancing area 320. The shaft 302 may be an articulated shaft, for example a cardan shaft.

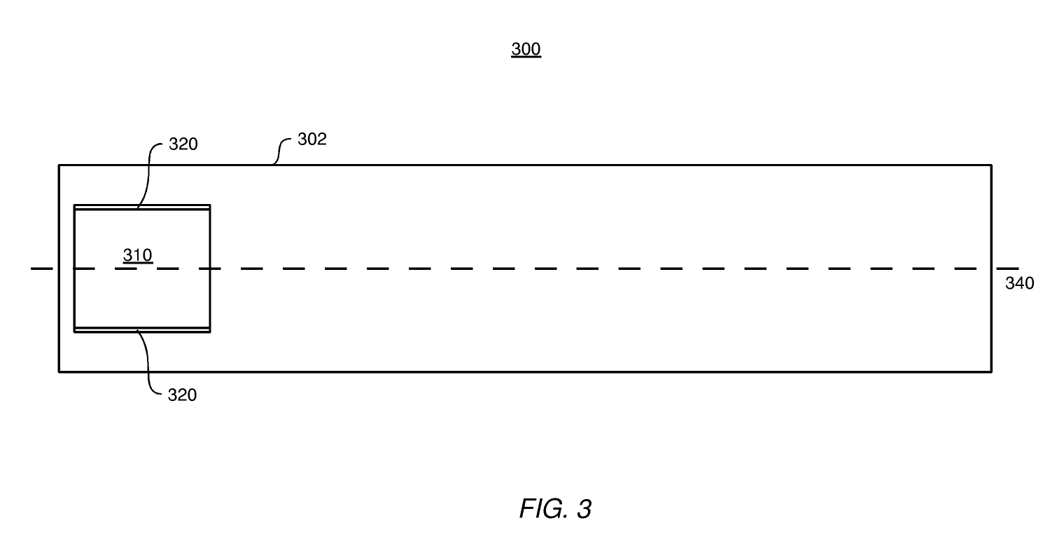

FIG. 3 shows a cross-sectional view of a chamber 310 in a shaft 302, such as a driveshaft 132, 136-139, according to another embodiment of the invention. The chamber 310 is caved into the shaft 302, and extends partially along the shaft 302 in an end section of the shaft 302. The chamber 310 may be sealed or closed with a lid. The shaft 302 is rotatable about a rotational axis 340. The chamber 310 comprises a circumferential balancing area 320.

The chamber 310 may have a diameter of between approximately 0.01 m and approximately 1 m, or between approximately 0.02 m and approximately 0.5 m, or between approximately 0.05 m and approximately 0.2 m, or approximately 0.1 m.

The chamber 310 may have a length of between approximately 0.01 m and approximately 2 m, or between approximately 0.02 m and approximately 1 m, or between approximately 0.05 m and approximately 0.5 m, or approximately 0.2 m.

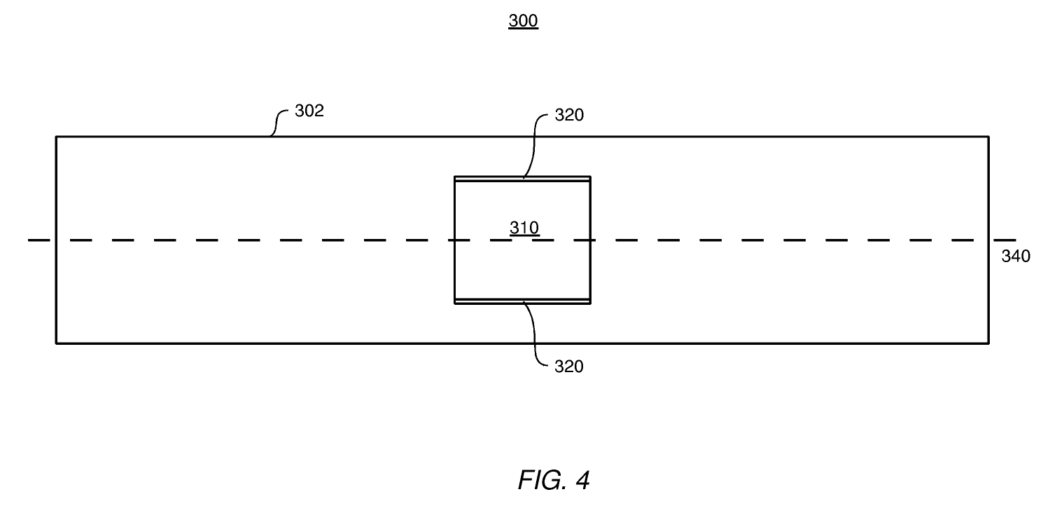

FIG. 4 shows a cross-sectional view of a chamber 310 in a shaft 302, such as a driveshaft 132, 136-139, according to yet another embodiment of the invention. The chamber 310 is caved into the shaft 302, and extends partially along the shaft 302 in a mid section of the shaft 302. The chamber 310 may be sealed or closed with a lid. The shaft 302 is rotatable about a rotational axis 340. The chamber 310 comprises a circumferential balancing area 320.

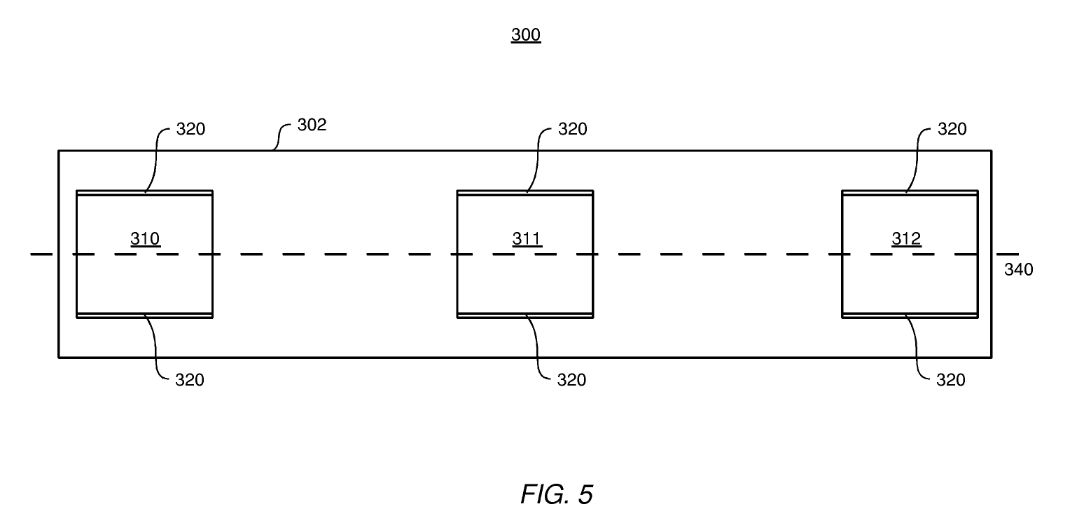

FIG. 5 shows a cross-sectional view of a plurality of chambers 310-312 in a shaft 302, such as a driveshaft 132, 136-139, according to yet another embodiment of the invention. The chambers 310-312 are caved into the shaft 302, and extend partially along the shaft 302 at a plurality of locations along the shaft 302.

The thixotropic balancing substance 330 operates in the chamber 310-312. Owing to vibration, the thixotropic balancing substance 330 distributes itself along the circumferential balancing area 320, such that a centre of gravity 350 moves towards the rotational axis 340 of the rotational element 300, such as the shaft 302, and the vibration is reduced or minimized or eliminated.

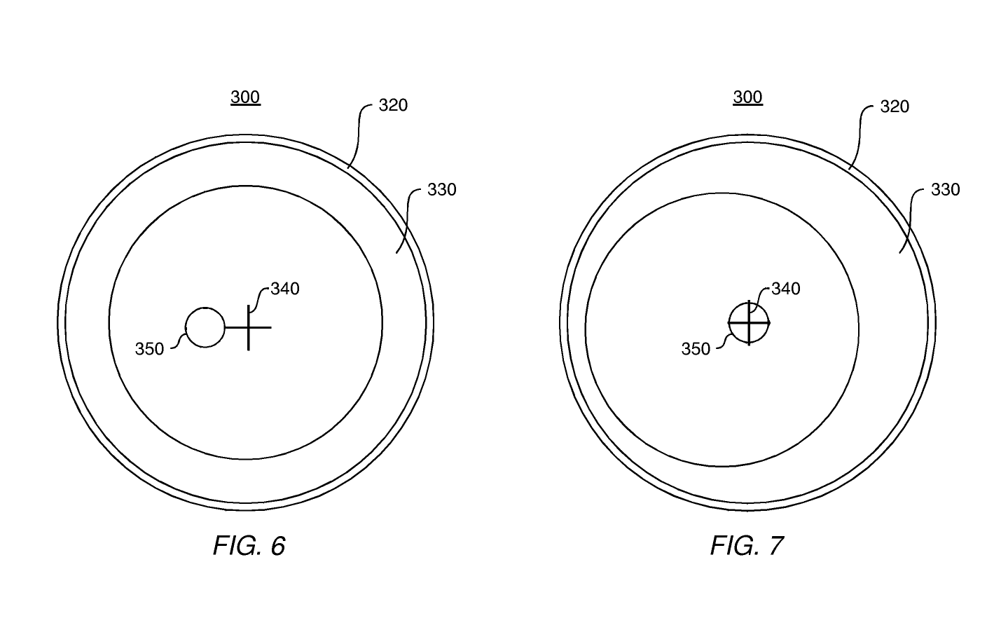

FIG. 6 shows, for a preferred embodiment of the invention, a cross-sectional view of the cylindrical chamber 310 at an initial point in time, when the thixotropic balancing substance 330 partially fills the chamber 310. The thixotropic balancing substance 330 may be evenly distributed along the circumferential balancing area 320 as shown in FIG. 6. For a vertical rotational axis 340, the thixotropic balancing substance 330 may partially fill the chamber 310 to an even level perpendicular to the rotational axis 340. For a horizontal rotational axis 340, the thixotropic balancing substance 330 may partially fill the chamber 310 to an even level along the rotational axis 340. Owing to an imbalance of the rotational element 300, a CofG 350 is offset from the rotational axis 340.

FIG. 7 shows, for the preferred embodiment of the invention, a cross-sectional view of the cylindrical chamber 310 at a point in time, when the thixotropic balancing substance 330 is distributed along the circumferential balancing area 320 of the chamber 310, such that the vibration is reduced. As the rotational element 300 rotates about the rotational axis 340, the thixotropic balancing substance 330 liquefies owing to vibration in the rotary system 120, 130 and distributes along the circumferential balancing area 320 of the chamber 310, such that an imbalance of the rotational element 300 is reduced, and, thus, the vibration is reduced. The CofG 350 moves towards the rotational axis 340. When the vibration is reduced, the thixotropic balancing substance 330 may solidify and maintain its position and distribution on the circumferential balancing area 320.

The amount of said thixotropic balancing substance 330 may be between approximately 0.01 kg and approximately 20 kg, or between approximately 0.1 kg and approximately 2 kg, or between approximately 0.2 kg and approximately 1 kg, or approximately 0.5 kg. The chamber 310 may be filled with the amount of said thixotropic balancing substance 330 to between approximately 1% and approximately 90%, or between approximately 10% and approximately 80%, or between approximately 25% and approximately 75%, or approximately 50%.

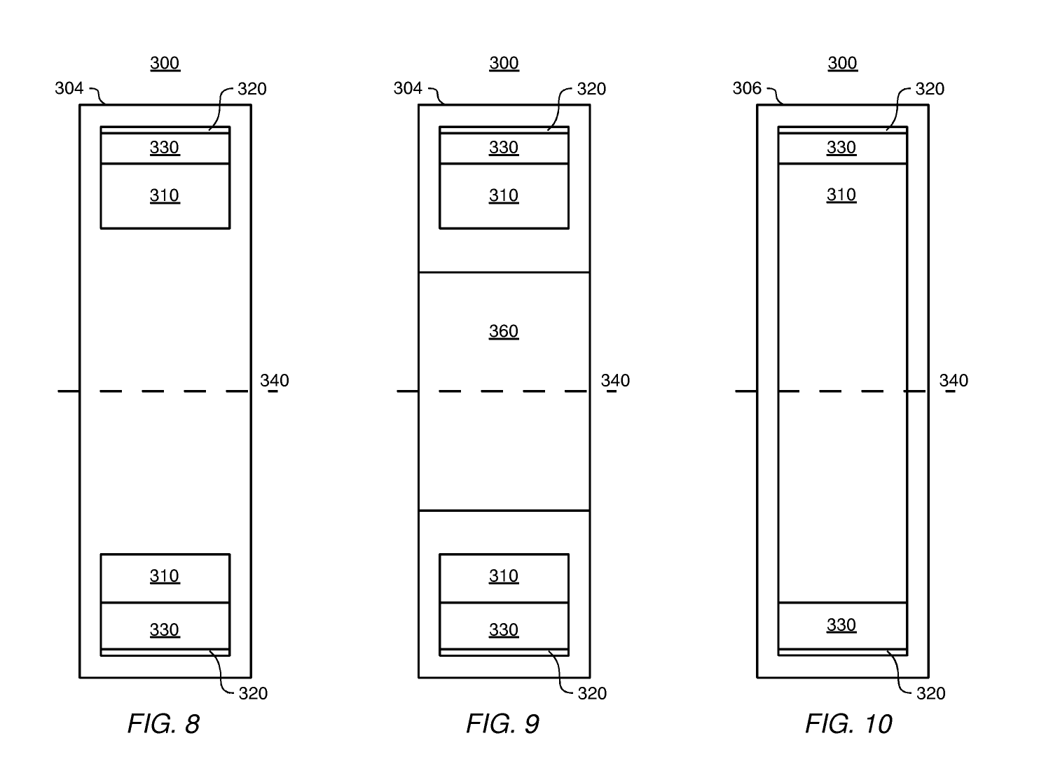

FIG. 8 shows a cross-sectional view of a chamber 310 in a rotational element 300, 304 according to yet another embodiment of the invention. The chamber 310 is caved into the rotational element 300, 304, such as a flywheel, a gearing wheel or an additional element, for example a container or vessel. The chamber 310 is annular or ring-shaped. The chamber 310 may have a cross section being rectangular, square (not shown), semicircle-shaped (not shown), bell-shaped (not shown), circular (not shown) or the like.

FIG. 9 shows a cross-sectional view of a chamber in a rotational element 300, 304 according to yet another embodiment of the invention. With reference to FIG. 8, the rotational element 300, 304 comprises a centre hole 360. The centre hole 360 may be circular, square (not shown), hexagonal (not shown) or the like. The centre hole 360 of the rotational element 300, 304 may receive a shaft, for example a driveshaft 132, 136-139, for coupling the rotational element 300, 304 to the rotational system 120, 130.

FIG. 10 shows a cross-sectional view of a chamber 310 in another rotational element 300, 306 according to yet another embodiment of the invention. The chamber 310 is caved into the other rotational element 300, 306, such as a flywheel, a gearing wheel or an additional element, for example a container or vessel. The chamber 310 is cylindrical. The chamber 310 may have a cross section being rectangular, square (not shown), semicircle-shaped (not shown), bell-shaped (not shown), circular (not shown) or the like.

A train is a series of vehicles, that is rolling stock, moving along a railway track to transport passengers or freight from one place to another. The series of vehicles generally comprises a locomotive and optionally comprises unpowered vehicles. The railway track, that is railroad track, is the surface structure supporting and guiding the train. The railway track generally comprises two rails on which the vehicle wheels run, a series of lateral timber or concrete sleepers, that is ties, and a crushed stone ballast bed. A rail is a hot-rolled steel profile of a specific shape or cross section (an asymmetrical I-beam) designed for use as the fundamental component of railway track. As an alternative, the railway track may comprise a monorail. The trains comprise passenger trains, for example long-distance trains, such as high-speed trains, magnetic levitation (maglev) trains, inter-city trains and regional trains, and short-distance trains, such as commuter trains, rapid transit, tram, light rail, underground and monorail trains, and freight trains.

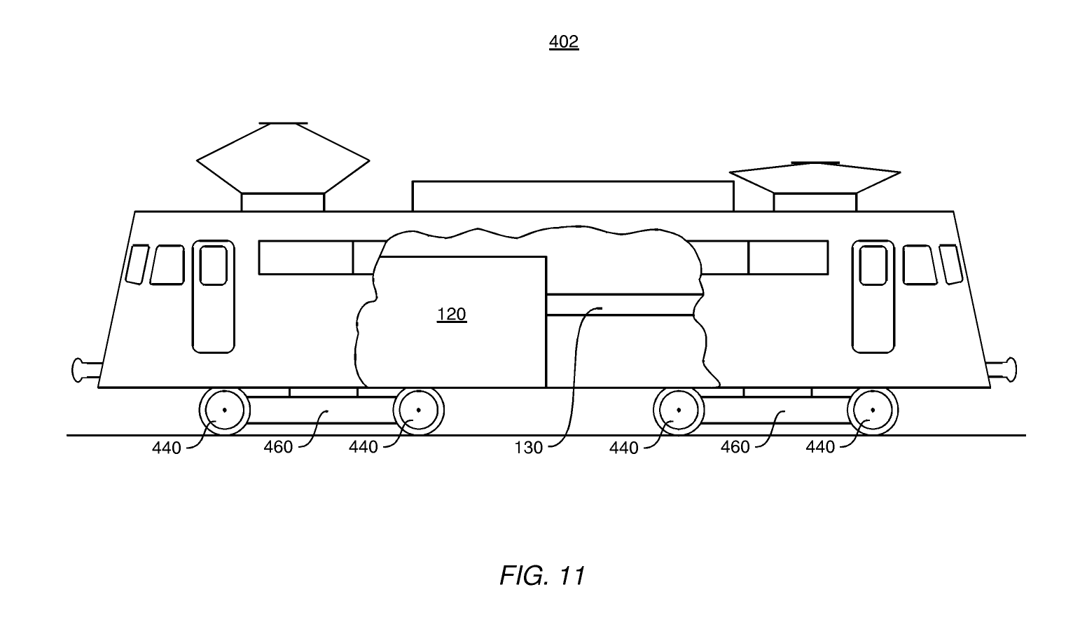

FIGS. 11 to 13 show a schematic view of rolling stock, such as a locomotive, passenger car 404 and freight car 406, to which the invention may be applied.

Rolling stock comprises vehicles that move on a railway track, that is one or more rails. The rolling stock and the rails form a closely concerted system, that is a wheel-rail system. The vehicles comprise both powered vehicles, that is running stock, and unpowered vehicles. Running stock comprises, for example, locomotives and self-propelled payload-carrying vehicles.

A locomotive is a piece of rolling stock designed to provide motive power for a train. The locomotive has no payload capacity of its own, and its sole purpose is to move the train along the tracks. The locomotive may generate motive power with an engine. The engine may be an electric engine 120 as indicated in FIG. 11. The engine may generally be a steam, Diesel, Diesel-mechanical, Diesel-electric, electro-Diesel, Diesel-hydraulic, Diesel-steam, hydrogen, gas turbine-electric, pneumatic, that is pressurized gas, for example air, or hybrid engine.

Locomotives generally pull trains from the front. However, in a push-pull operation locomotives may pull the train in one direction and push it in the other, and can be controlled from a control cab at the other end of the train.

FIG. 11 shows a schematic view of a locomotive, such as an electric locomotive 402, to which the invention may be applied. The electric locomotive 402 comprises an engine or motor 120, a powertrain or powerplant 130, and wheelsets 440. The electric locomotive 402 may further comprise bogies 460, each of which comprising two, three or more wheelsets 440.

The engine 120 may comprise a rotational element 300, 302-306 according to the invention as already described.

The powertrain 130 may comprise a rotational element 300, 302-306 according to the invention as already described.

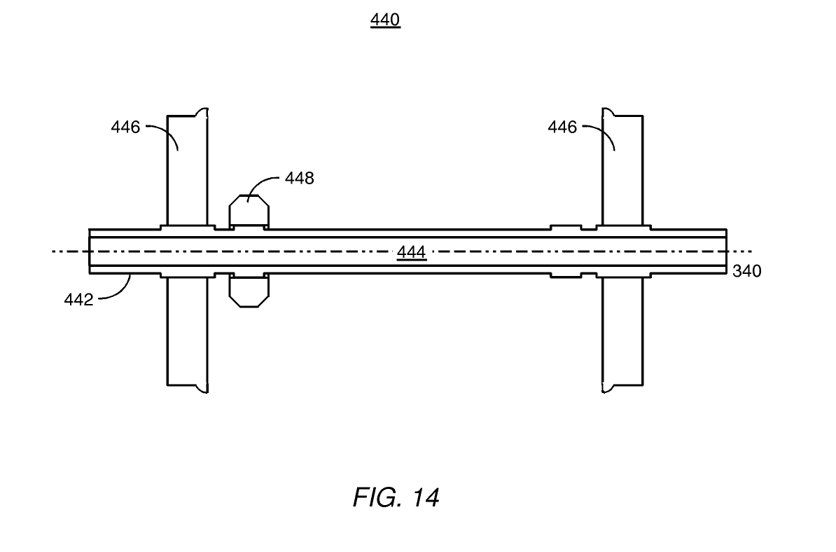

One, two, three or more of the wheelsets 440 may comprise a rotational element 300, 302-306 according to the invention as will be described with reference to FIG. 14.

Thus, vibration in the engine 120, powertrain 130 or wheelsets 440 of the electric locomotive 402, and running stock in general, may be reduced by providing the rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of the thixotropic balancing substance 330; and balancing the rotary system, that is engine 120, powertrain 130, wheelsets 440 or any combination thereof.

Running stock also comprises self-propelled payload-carrying vehicles, that is multiple units, motor coaches or railcars. The self-propelled payload-carrying vehicles are increasingly common for passenger trains, and less frequently seen for freight trains, for example CargoSprinter. The self-propelled payload-carrying vehicles comprise high-speed trains, such as German Intercity-Express (ICE) and French Train a Grande Vitesse (TGV). The ICE system comprises high-speed trains travelling in service at between 200 km/h and 320 km/h. The TGV system comprises trains travelling in service at up to 320 km/h. Thus, engines, powertrains, and one, two, three, more or all of the wheelsets 440 of a high-speed train may comprise a rotational element 300, 302-306 according to the invention as will be described with reference to FIG. 14.

Running stock also comprises power cars that provide motive power to haul an unpowered train, and have payload space or are rarely detached from their trains.

A passenger car, that is coach or carriage, is a piece of rolling stock designed to carry passengers as payload. Passenger cars also comprise a sleeping car, baggage car, dining car and railway post office car.

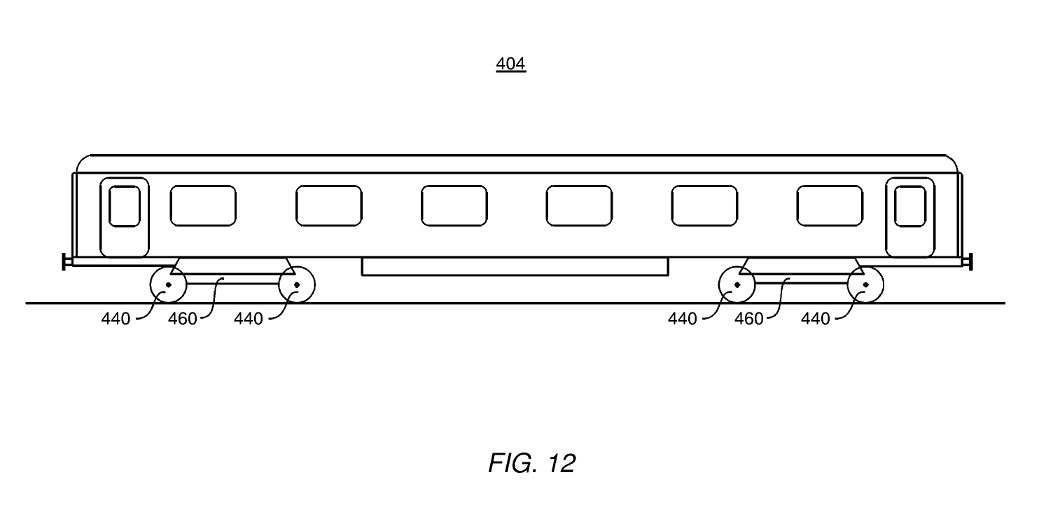

FIG. 12 shows a schematic view of a passenger car 404, to which the invention may be applied. The passenger car 404 comprises wheelsets 440. The passenger car 404 may further comprise bogies 460, each of which comprising one, two, three or more wheelsets 440.

One, two three or more of the wheelsets 440 may comprise a rotational element 300, 302-306 according to the invention as will be described with reference to FIG. 14.

Thus, vibration in the wheelsets 440 of the passenger car 404, and unpowered running stock in general, may be reduced by providing the rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of the thixotropic balancing substance 330; and balancing the rotary system, that is wheelset or wheelsets 440.

A freight car, that is goods wagon, is a piece of rolling stock designed to transport freight, that is goods, as payload. Freight cars comprise open wagons, that is gondolas, such as open wagons of standard design and open wagons of special design, for example self-discharging wagons, covered wagons, that is boxcars, such as ordinary classes, special classes, livestock wagons, that is stock cars, refrigerated wagons, flat wagons, wagons with a sliding roof, special wagons including powder wagons and low-loading wagons, tank wagons, and spine wagons to carry intermodal containers.

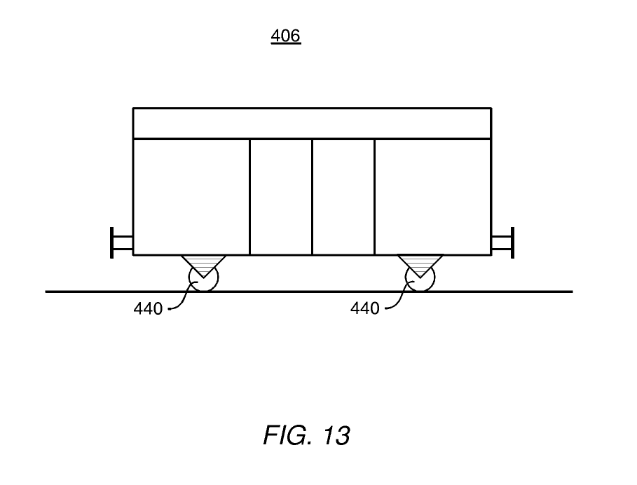

FIG. 13 shows a schematic view of a freight car, such as covered freight car 406, to which the invention may be applied. The covered freight car 406 comprises wheelsets 440. The covered freight car 406 may further comprise bogies 460, each of which comprising one, two, three or more wheelsets 440.

One, two three or more of the wheelsets 440 may comprise a rotational element 300, 302-306 according to the invention as will be described with reference to FIG. 14.

Thus, vibration in the wheelsets 440 of the freight car 406, and unpowered running stock in general, may be reduced by providing the rotational element 300, 302-306; 442, 446, 448 comprising a chamber 310-312; 444 having a fulcrum on a rotational axis 340 of said rotational element 300, 302-306; 442, 446, 448, comprising a circumferential balancing area 320 and being partially filled with an amount of the thixotropic balancing substance 330; and balancing the rotary system, that is wheelset or wheelsets 440.

Further, the invention may be applied to real rolling stock, such as a train in real life, as well as scale rolling stock, such as a model train.

The wheelset is an wheel-axle assembly of rolling stock and generally comprises an axle and two wheels spaced apart towards opposite ends of the axle. This may be an unpowered wheelset. The wheelset may further comprise a gear wheel for transmitting power from an engine to the wheelset, and, thus, providing for a powered wheelset. The wheelset may further comprise a brake disc for decelerating, that is breaking, the wheelset and, thus, rolling stock and train. Rolling stock comprises wheelsets beneath each of its end. Two, three or more wheelsets may be comprised in a frame assembly, that is bogie.

FIG. 14 shows a cross-sectional view of a wheelset 440 of the rolling stock, to which the invention may be applied.

The wheelset 440 comprises a axle 442 and two wheels 446 spaced apart on the axle 442. The axle 442 and the wheels 446 may comprise metal, for example steel. The axle 442 may be hollow and may comprise a chamber 444 having a fulcrum on a rotational axis 340. The axle 442 may comprise one, two, three or more chambers 310-312 having a fulcrum on the rotational axis 340, comprising a circumferential balancing area 320 and being partially filled with an amount of a thixotropic balancing substance 330 as already described. Alternatively, one, two, three or more chambers 310-312 may be attached to the axle 442. The one, two, three or more chambers 310-312 may be sealed.

The wheels 446 may comprise one, two, three or more chambers 310-312 having a fulcrum on the rotational axis 340, comprising a circumferential balancing area 320 and being partially filled with an amount of a thixotropic balancing substance 330 as already described. Alternatively, one, two, three or more chambers 310-312 may be attached to the wheels 446. The one, two, three or more chambers 310-312 may be sealed.

The wheelset 440 may comprise a gear wheel 448. The gear wheel 448 may be situated between the wheels 446, centric or excentric.

The wheelset 440 may be adapted for use on a standard railway track. Thus, the wheels 446 may be spaced apart by 136 cm and may have a diameter of 92 cm. The axle 442 may have a length of 218 cm and an outer diameter of 160 mm and an outer diameter of 179 mm for the wheels 446, and an outer diameter of 180 mm and 185 mm for the gear wheel 448 and a break disc, respectively. The axle 442 may be hollow and have an inner diameter of 70 mm. The measurements are exemplary and may be adapted within established standards and technical needs. The wheelset 440 may be adapted for use in a high-speed trains, such as an ICE train.

The thixotropic balancing substance 330 may be a thixotropic tyre balancing composition disclosed in EP patent application 0 281 252 and corresponding U.S. Pat. No. 4,867,792, having a yield stress value between 1 Pa and 260 Pa being capable of balancing tyres by being able to flow under the influence of the vibrations induced when a heavy spot on the tyre hits the road surface. Alternatively, the thixotropic balancing substance may have a yield stress value greater than 2 Pa. However, owing to the lower yield stress value, a lower rotational acceleration may be necessary, especially if the rotational element is not in a vertical position.

Rheological properties of a balancing substance are its Critical Yield Stress (CYS) and Elastic (Storage) Modulus (G′), both measured in the linear visco-elastic region, as well as its Yield Stress as determined in stress growth measurements and the relationship between its storage modulus (G′) and its loss modulus (G″), measured by a frequency sweep.

Storage modulus (G′) is a measure of the strength of the substance, that is the strength and the number of bonds between the molecules of the gel former.

Loss modulus (G″) is a measure of a substance's ability to dissipate energy in the form of heat.

The relationship between G′ and G″ as measured in a frequency sweep is a structural characterization of a substance. The cross-over frequency is the frequency at which G″ becomes greater than G′.

Of equal importance as the visco-elastic properties is a long term stability of the balancing substance in service, the performance at various temperatures of the substance, and the chemical inertness of the substance.

A balancing substance should remain functional during the life time of the balancing system and under the various conditions, in particular within a temperature range from approximately −50° C. or −30° C. to +90° C.

Furthermore, the balancing substance must not have any harmful effect on the balancing system and environment and should be disposable or recyclable.

In more detail, the thixotropic balancing substance may be a balancing gel comprising two components, namely, a base liquid and a gel former, and preferably fulfilling minimum criteria comprising, the regard to rheology, a storage modulus (G′) between approximately 100 Pa and approximately 5000 Pa, a cross-over frequency (G″>G′) between approximately 1 Hz and approximately 40 Hz and a critical yield stress value greater than approximately 1 Pa; with regard to volatility, an evaporation loss of less than approximately 6% by weight after 10 hours at 99° C.; a pour point of the base liquid lower than approximately −15 ° C. according to the Standard Test Method for Pour Point of Petroleum Products, ASTM D97; with regard to separation stability, a separation of the base liquid of less than approximately 20% by weight after 12 hours at 300 000×g and 25° C.; and, with regard to chemical reactivity, substantial inertness, such as non-corrosiveness to metals and no effect on polymers, such as rubber. The balancing gel typically comprises, by weight, between approximately 75% and approximately 99%, for example between approximately 85% and approximately 97%, such as approximately 95% of the base liquid, and, correspondingly, between approximately 1% and approximately 25%, for example between approximately 3% and approximately 15%, such as approximately 5% of the gel former. The balancing gel may further comprise, preferably in minor amounts, a corrosion inhibitor, an anti-oxidant, a dye or a combination thereof.

The base liquid may, for example, comprise a polyalkylene glycol (PAG), such as a polypropylene glycol (PPG) or a polyethylene glycol (PEG); a combination, that is a mixture, of PAGs, such as a combination of a PPG and a PEG; a copolymer of ethylene oxide and propylene oxide; or a combination thereof.

The base liquid may comprise an alcohol-(ROH-)started polymer of oxypropylene groups having a generalized formula:

RO—[CH(CH₃)CH₂—O-]ₘH, (1)

where R is hydrogen or an alkyl group, having one terminal hydroxyl group and being water-insoluble, such as products with a variety of molecular weights and viscosities marketed by DOW Chemical Company (www.dow.com) under the trade mark UCON LB Fluids.

The base liquid may, alternatively or additionally, comprise an alcohol-(ROH-)started linear random copolymer of ethylene oxide and propylene oxide having a generalized formula:

RO—[CH(CH₃)CH₂—O-]ₘ[CH₂—CH₂—O-]ₙH, (2)

where R is hydrogen or an alkyl group.

The base liquid may, alternatively or additionally, comprise an alcohol-(ROH-)started random copolymer of ethylene oxide and propylene oxide preferably comprising approximately equal amounts, that is approximately 50%, by weight of oxyethylene groups and oxypropylene groups, having one terminal hydroxyl group and being water-soluble at ambient temperature, that is at temperatures below approximately 40° C., such as products with equal amounts by weight of oxyethylene groups and oxypropylene groups and with a variety of molecular weights and viscosities marketed by DOW Chemical Company under the trade mark UCON 50-HB Fluids. For example, the base liquid may, alternatively or additionally, comprise a butanol-started random copolymer of ethylene oxide and propylene oxide comprising equal amounts by weight of oxyethylene groups and oxypropylene groups with a numbered average molecular weight of 3930, a viscosity of approximately 1020 cSt at 40° C. and a viscosity grade of approximately 1000 according to ISO 3448, such as a product marketed by DOW Chemical Company under the trade mark UCON 50-HB-5100.

The base liquid may, alternatively or additionally, comprise a diol-started random copolymer of ethylene oxide and propylene oxide preferably comprising approximately 75% by weight oxyethylene groups and, correspondingly, approximately 25% by weight oxypropylene groups, having two terminal hydroxyl groups (R═H) and being water-soluble at temperatures below approximately 75° C., such as products with a variety of molecular weights and viscosities marketed by DOW Chemical Company under the trade mark UCON 75-H Fluids. For example, the base liquid may, alternatively or additionally, comprise a diol-started random copolymer of ethylene oxide and propylene oxide comprising 75% by weight oxyethylene groups and 25% by weight oxypropylene groups with a numbered average molecular weight of 6950 and a viscosity of approximately 1800 cSt at 40° C., such as a product marketed by DOW Chemical Company under the trade mark UCON 75-H-9500.

The base liquid may, alternatively or additionally, comprise an alcohol-(ROH-)started random copolymer of ethylene oxide and propylene oxide preferably comprising approximately 40% by weight of oxyethylene groups and, correspondingly, approximately 60% by weight oxypropylene groups and being water-soluble, such as products with a variety of molecular weights and viscosities marketed by DOW Chemical Company under the trade mark SYNALOX 40. For example, the base liquid may, alternatively or additionally, comprise an alcohol-started random copolymer of ethylene oxide and propylene oxide comprising 40% by weight of oxyethylene groups and 60% by weight oxypropylene groups with a numbered average molecular weight of 5300, a viscosity of 1050 cSt at 40° C. and a viscosity grade of approximately 1000 according to ISO 3448 such as a product marketed by DOW Chemical Company under the trade mark SYNALOX 40-D700.

The base liquid may, alternatively or additionally, comprise a diol-started random copolymer of ethylene oxide and propylene oxide preferably comprising approximately 50% by weight of oxyethylene and, correspondingly, approximately 50% by weight oxypropylene groups with a kinematic viscosity of 960-1160 cSt (or mm²/s) at 40° C. ASTM D445 such as a product marketed by DOW Chemical Company under the trade mark SYNALOX 50-D700.

The gel former may comprise fumed silica, for example hydrophobic silica or hydrophilic silica, preferably having a BET (Brunauer, Emmett, Teller) surface between approximately 50 m²/g and approximately 400 m²/g, for example a hydrophilic fumed silica having a BET surface of 300 m²/g, such as a product marketed by Evonik Industries (www.evonik.com) under the trade mark Aerosil A300.

The gelling effect of the gel formers on the oils is accomplished by the formation of a network of the molecules of the gel former through hydrogen bonding via hydroxy groups or via van der Waals attraction between segments molecules of the gel former. The number and the strength of these bonds determines the gel strength, and the ability of the gel to support a load (critical yield stress).

The thixotropic balancing substance may be a balancing gel comprising a balancing gel composition comprising

1) 85 to 97% by weight of a glycol ether component comprising one or more ethylene/propylene glycol copolymer ethers of the general formula (I) or the general (II) or mixtures thereof

R—O{[CH(CH3)CH2—O-]m[CH2—CH2—O-]n}H (I)

R1—(O—{[CH(CH3)CH2—O-]m[CH2—CH2—O-]n}H)2 (II)

wherein R is hydrogen or an alkyl group of 2-8 carbon atoms; R1 is an alkylene moiety of 2-8 carbon atoms in which the two substituents are not carried on the same carbon atom; m is the mole percentage of propylene glycol in the ethylene/propylene glycol copolymer moiety or moieties; and n is the mole percentage of ethylene glycol in the ethylene/propylene glycol copolymer moiety or moieties, wherein the ratio n:m is in the range from 35:65 to 80:20; each glycol copolymer compound having a number average molecular weight in the range of 2000-10000; and

2) 3 to 15% by weight of a fumed silica gel former; said balancing composition being visco-elastic and having a storage modulus (G′) between 1500 Pa and 5000 Pa at 22° C., a loss modulus (G″) smaller than the storage modulus up to a cross-over frequency of 10-40 Hz, and a Critical Yield Stress exceeding 2 Pa.

The number average molecular weight of the glycol ether component(s) may be in the range of 3000-10000. The ratio n:m may be in the range from 35:65 to 80:20, preferably in the range from 40:60 to 75:22, in particular from 40:60 to 60:40, such as 50:50. The fumed silica gel former may be a hydrophilic type fumed silica having a BET surface area of from 90 to 400 m²/g, preferably from 200 to 300 m²/g; or the fumed silica gel former is a hydrophobized type fumed silica having has a BET surface area of from 50 to 300 m²/g, preferably from 250 to 350 m²/g; or mixtures of such hydrophilic and hydrophobized type fumed silica gel formers. The glycol ether component(s) may exhibit a Viscosity Grade determined according to ISO3448 of above 500, preferably in the range of 800-1200.

The compositions of the invention are typically made by mixing together the ingredients, if necessary under slight heating to below approximately 40° C.

Using base liquids and gel formers as described above, a series of exemplary balancing substances have been prepared. The compositions are shown in Table 1.

TABLE 1
Balancing Substance Formulations (in % by weight)

| Composition | Aerosil | UCON 75- | UCON 50- | SYNALOX |
|---|---|---|---|---|
| # | A300 | HB-9500 | HB-5100 | D50-700 |
| 1 | 4 | 0 | 96 | 0 |
| 2 | 4 | 0.5 | 95.5 | 0 |
| 3 | 4 | 0 | 0 | 96 |
| 4 | 4 | 0.5 | 0 | 95.5 |
| 5 | 5 | 0 | 95 | 0 |
| 6 | 5 | 0.5 | 94.5 | 0 |
| 7 | 5 | 0 | 0 | 95 |
| 8 | 5 | 0.5 | 0 | 94.5 |
| 9 | 6 | 0 | 94 | 0 |
| 10 | 6 | 0.5 | 93.5 | 0 |
| 11 | 6 | 0 | 0 | 94 |
| 12 | 6 | 0.5 | 0 | 93.5 |

The chamber 310 may further comprise a weight body (not shown) being in contact with the thixotropic balancing substance 330 and contributing to balancing of the rotary system 120, 130. The weight body has, defined by a body size of the weight body, a body surface and a body weight, such that the weight body overcomes adhesion between the body surface and the thixotropic balancing substance 330 when the thixotropic balancing substance 330 is subjected to the vibration and changes into an agitated state. The body size ensures movability of the weight body in the chamber 310 with the thixotropic balancing substance 330 therein. The weight body may be a ball. The body size corresponds with a diameter of the ball. The diameter may be determined by a ratio between the body surface according to:

A=4 pi r̂2, (3)

where r is a radius of the ball, accounting for surface structure, i. e. roughness, and adhesion, and a body volume according to:

V=4/3 pi r̂3, (4)

where r is a radius of the ball, accounting for body density and body weight. For increasing radius r, the volume, and therefore body weight, increases faster than the body surface, and movability of the weight body in the chamber 310 increases. The weight body may comprise metal, for example steel, such as stainless steel.

Embodiments of the inventions comprise a corresponding apparatus, that may carry out the method.

Embodiments of the inventions comprise a corresponding system, that may carry out the method, possibly across a number of devices.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention is, therefore, to be determined with reference to the appended claims, along with the full scope of equivalents to which such claims are entitled.

1. A method of reducing vibration in a rotary system of a motor vehicle, comprising:
providing a rotational element comprising a chamber having a fulcrum on a rotational axis of said rotational element, comprising a circumferential balancing area and being partially filled with an amount of a balancing substance; and
balancing said rotary system by distributing said amount of said balancing substance in said chamber, wherein
said rotary system is an engine system or a power transmission system of said motor vehicle; and
said balancing substance is a thixotropic balancing substance that, owing to said vibration, changes from a relaxed state into an agitated state and distributes itself.

2-11. (canceled)

12. The method of claim 1, wherein said thixotropic balancing substance has a yield stress value between approximately 1 Pa and approximately 400 Pa.

13. The method of claim 1, further comprising:
rotating said rotational element about the rotational axis, such that said thixotropic balancing substance liquefies and distributes itself along the circumferential balancing area, and an imbalance of said rotational element is reduced.

14. The method of claim 1, further comprising:
orienting said rotational axis horizontally; or
orienting said rotational axis vertically

15. The method of claim 1, further comprising:
providing said rotational element as an original element of said rotary system, a replacement element of said rotary system, or a supplemental element to said rotary system;
providing said rotational element as a hollow shaft or tubular shaft;
providing said rotational element as an articulated shaft, for example a cardan shaft; or
a combination thereof.

16. The method of claim 1, further comprising
providing said rotational element as a crankshaft.

17. The method of claim 1, further comprising:
providing said power transmission system as a powertrain or powerplant;
providing said rotational element as a shaft, a flywheel or a container; or
a combination thereof.

18. The method of claim 1, further comprising:
providing said chamber as annular or ring-shaped, or cylindrical chamber;
providing said chamber with a cross section being rectangular, square, semicircle-shaped, bell-shaped or circular;
providing said chamber with a diameter of between approximately 0.01 m and approximately 1 m, or between approximately 0.02 m and approximately 0.5 m, or between approximately 0.05 m and approximately 0.2 m, or approximately 0.1 m;
providing said chamber with a length of between approximately 0.01 m and approximately 2 m, or between approximately 0.02 m and approximately 1 m, or between approximately 0.05 m and approximately 0.5 m, or approximately 0.2 m; or
a combination thereof.

19. The method of claim 1, further comprising:
providing said amount of said thixotropic balancing substance as between approximately 0.01 kg and approximately 20 kg, or between approximately 0.1 kg and approximately 2 kg, or between approximately 0.2 kg and approximately 1 kg, or approximately 0.5 kg;
filling said chamber with the amount of said thixotropic balancing substance to between approximately 1% and approximately 90%, or between approximately 10% and approximately 80%, or between approximately 25% and approximately 75%, or approximately 50%; or
a combination thereof.

20. An apparatus for reducing vibration in a rotary system of a motor vehicle, comprising:
a rotational element comprising a chamber having a fulcrum on a rotational axis of said rotational element, comprising a circumferential balancing area and being partially filled with an amount of a thixotropic balancing substance, wherein said rotary system is an engine system or a power transmission system of said motor vehicle; and said balancing substance is a thixotropic balancing substance that, owing to said vibration, changes from a relaxed state into an agitated state and distributes itself.

21. A rotary system of a motor vehicle for reducing vibration in said rotary system, comprising:
a rotational element comprising a chamber having a fulcrum on a rotational axis of said rotational element, comprising a circumferential balancing area and being partially filled with an amount of a balancing substance, wherein said rotary system is an engine system or a power transmission system of said motor vehicle; and said balancing substance is a thixotropic balancing substance that, owing to said vibration, changes from a relaxed state into an agitated state and distributes itself.
